(19) United States
(12) Patent Application Publication
(10) Pub. No.: US 2023/0249421 A1
(43) Pub. Date: Aug. 10, 2023

(54) A METHOD OF MANUFACTURING A SHELL OF A WIND TURBINE BLADE

(71) Applicant: LM WIND POWER A/S, Kolding (DK)

(72) Inventor: Pavlo ZHURAVLOV, Heerhugowaard (NL)

(21) Appl. No.: 18/015,166

(22) PCT Filed: Jul. 8, 2021
(86) PCT No.: PCT/EP2021/069021

§ 371 Date: Jan. 9, 2023

(30) Foreign Application Priority Data
Jul. 10, 2020 (GB) 2010664.7

(51) Int. Cl. B29C 70/54; B29C 65/78; B29C 70/44

(52) U.S. Cl. CPC B29C 70/541; B29C 65/7817; B29C 70/443; B29D 99/0028

(57) ABSTRACT

A method of manufacturing a shell (36 and 38) of a wind turbine blade (10) is disclosed. The method comprises providing a mould (9) having a marker (11) at pre-determined locations. One or more layers of fiber fabrics are provided on surface of the mould (9) to form a shell half structure (36 and 38). Resin is infused through the one or more layers of fiber fabrics and subsequently cured to obtain the shell half structure (36 and 38). A reference portion (19) is marked on the shell half structure (36 and 38) to assemble one or more components on the shell half structure (36 and 38), by detecting a location of the marker (11) in the mould (9) by a detection device (13). The above method facilitates accurate positioning of component such as shear webs (7).

### FIELD OF THE INVENTION

The present disclosure relates to the field of wind energy. Particularly but not exclusively, the present disclosure relates to a method of manufacturing a shell of a wind turbine blade and a mould for manufacturing the shell of the wind turbine blade. Further embodiments of the present disclosure disclose a mould with embedded markers which indicate the position where various components are to be mounted in the shell of the wind turbine blade.

### BACKGROUND OF THE DISCLOSURE

Wind power is one of the fastest-growing renewable energy technologies and provides a clean and environmentally friendly source of energy. Typically, wind turbines comprise a tower, generator, gearbox, nacelle, and one or more rotor blades. The kinetic energy of wind is captured using known airfoil principles. Modern wind turbines may have rotor blades that exceed 90 meters in length.

Wind turbine blades are usually manufactured by forming a shell body from two shell parts or shell halves comprising layers of fabric or fiber and resin. Spar caps or main laminates are placed or integrated in the shell halves and may be combined with shear webs or spar beams to form structural support members. Spar caps or main laminates may be joined to, or integrated within, the inside of the suction and pressure halves of the shell.

The shell halves of wind turbine blades are usually manufactured using moulds. First, a blade gel coat or primer is typically applied to the mould. Subsequently, fiber reinforcement and/or fabrics are placed into the mould followed by resin infusion. A vacuum is typically used to draw resin material into the mould. Several other moulding techniques are also known for manufacturing wind turbine blades, including compression moulding and resin transfer moulding. The resin is allowed to cure, and a shear web or shear box is positioned in the shells before the shell halves are joined together. The shell halves are further assembled by bonding them together along a chord plane of the blade at bond lines along the trailing and leading edges of the blade. The bond lines are generally formed by applying a suitable bonding paste or adhesive along the bond line at a minimum designed bond width between the shell members.

Further, in the above-mentioned process of manufacturing the wind turbine blades, it is crucial for the accurately locating of the position where the shear web has to be mounted on the wind turbine shell. Shear webs inside the wind turbine blades are load bearing structures and provide structural rigidity to the wind turbine blades. The position at which the shear web is to be mounted on the shell of a wind turbine blade becomes crucial since the shear webs often take the entire load of both the shells in the wind turbine blade. Conventionally devices such as laser and arch tools have been used to locate the position on the shells at which the shear webs are to be mounted.

U.S. Pat. No. 9,932,958B2 discloses an apparatus that comprises of one or more jigs. Theses jigs are configured to receive one or more spacer elements. Further, a first and second shear web panels are placed on the one or more jigs to align the first and the second shear webs. The first and second shear web panels are restrained relative to each other and are separated by the one or more spacer elements. The first and second shear web panels are then removed together with one or more spacer elements from the jig. The above-mentioned method of locating the position and further aligning the shear webs using components such as jigs and spacers provide low accuracy. These components i.e. jigs and spacer elements, together constitute arch tools. Arch tools are often bulky and handling them becomes difficult. Further, arch tools are highly sensitive to placement and dirt. Consequently, the calibration from these arch tools are vague and thus accuracy of positioning the shear web will also be low.

Further, lasers have also been used for web positioning along the shells of the wind turbine blade. However, lasers are not reliable if the floor on which the shell of the wind turbine blade is positioned is uneven. Uneven flooring may cause the positioning of the shear webs to be distorted since the markings indicated from the lasers may become inaccurate. Consequently, the assembling of the shells of the wind turbine blade is limited to industrial units with even floors. Further, the flexibility of transporting the shells of the wind turbine blade along with the shear web and assembling them on-site becomes unfeasible as laser equipment are bulky and uneven flooring may the system less reliable.

The present disclosure is directed to overcome one or more limitations stated above.

The information disclosed in this background of the disclosure section is only for enhancement of understanding of the general background of the invention and should not be taken as an acknowledgment or any form of suggestion that this information forms the prior art already known to a person skilled in the art.

### SUMMARY OF THE DISCLOSURE

In a non-limiting embodiment of the disclosure, a method of manufacturing a shell of a wind turbine blade is disclosed. The method comprises of providing a mould having a marker at pre-determined locations. One or more layers of fiber fabrics are provided on surface of the mould to form a shell half structure. Resin is infused through the one or more layers of fiber fabrics and subsequently cured to obtain the shell half structure. A reference portion is marked on the shell half structure to assemble one or more components in the shell, by detecting a location of the marker in the mould by a detection device. The detection device is preferable a radar type detection device.

Having the detection device being a radar type detection device allows the marker to be precisely located, both in terms of depth location and spatial coordinates on the mould surface. Further, it allows for non-magnetic and magnetic materials to be used as markers and allows the fiber fabrics layers to be thicker, such that the laminate may be up to 150 mm thick, while still being able to detect the markers with a detection analyses of a few mm.

In an embodiment, the marker extend along a length of the mould and the marker is metallic or non-metallic marker.

In an embodiment, the location of the marker is detected by positioning the detection device on the surface of the shell half structure.

In an embodiment, the detection device is a radar type detection device.

In an embodiment, the reference portions on the surface of the shell half structure are made at a distance of ranging from 500 mm to 3000 mm along the surface of the shell half structure.

In an embodiment, the marker are made of at least one of steel or aluminium.

In an embodiment, the at least one component positioned on the shell half structure with reference to the detected location of the marker is either a shear web, box beam, spar beam or box spar.

In another non-limiting embodiment of the disclosure, a method of manufacturing a wind turbine blade having a profiled contour including a pressure side and a suction side, and a leading edge and a trailing edge with a chord having a chord length extending therebetween, the wind turbine blade extending in a spanwise direction between a root end and a tip end is disclosed. The method comprises of providing a mould having a marker at pre-determined locations. One or more layers of fiber fabrics are provided on surface of the mould to form a shell half structure. Resin is infused through the one or more layers of fiber fabrics and subsequently is cured to obtain the shell half structure. A reference portion is marked to assemble one or more components in at least one of the shell half structure, by detecting a location of the marker in the mould by a detection device. A shear web is fixed with reference to the marked location in an inner surface of at least one of the first shell half and the second shell half structure. The first shell half structure is joined with the second shell half structure to obtain a wind turbine blade.

In an embodiment, the layers of fiber fabrics on the mould are either of aramid fiber fabrics, glass fiber fabrics, carbon fiber fabrics or hybrid fiber fabrics made of glass and carbon.

In yet another non-limiting embodiment of the disclosure, a mould for manufacturing a shell of a wind turbine blade is disclosed. The mould comprises an inner surface and an outer surface, wherein the inner surface is defined by an aerodynamic shape of the wind turbine blade and extends in a spanwise direction. At least one marker is embedded within the inner surface of the blade shell at a predetermined depth from the inner surface of the blade shell, wherein the marker for positioning a component on an inner surface of the blade shell is detected by a detection device.

In an embodiment, the at least one marker is integrally laid in the mould or positioned in a groove defined in the inner surface of the mould.

In an embodiment, the predetermined depth from the inner surface ranges from about 20 mm to about 150 mm.

In still another non-limiting embodiment of the disclosure, a system for determining reference location in a wind turbine blade to mount one or more components in the shell half structure is disclosed. The system comprises of a mould according to previous sections and a detection device is configured to detect the location of at least one marker in the mould by positioning a detection device on surface of a shell half structure.

### BRIEF DESCRIPTION OF THE ACCOMPANYING FIGURES

The invention is explained in detail below with reference to an embodiment shown in the drawings, in which:

FIG. 1 shows a perspective view of the wind turbine, in accordance with an embodiment of the disclosure.

FIG. 2 shows a perspective view of a wind turbine blade, in accordance with an embodiment of the disclosure.

FIG. 3 shows a cross-sectional view of the blade along axis I-I shown in FIG. 2, in accordance with an embodiment of the disclosure.

FIG. 4 illustrates a schematic view of a mould having marker, for manufacturing shell half structure of the wind turbine blade, and a detection device on the surface of the blade, in accordance with an embodiment of the disclosure.

FIG. 5 illustrates a side view of the mould along with marker mounted at pre-determined locations, in accordance with an embodiment of the disclosure.

FIG. 6 illustrates a perspective view of the mould mounted on a support structure, in accordance with an embodiment of the disclosure.

FIG. 7 illustrates an embodiment of the mould mounted on a support structure from the FIG. 6, in accordance with an embodiment of the disclosure.

FIG. 8 is a flowchart of the method of manufacturing a wind turbine blade, in accordance with an embodiment of the present disclosure.

### DETAILED DESCRIPTION

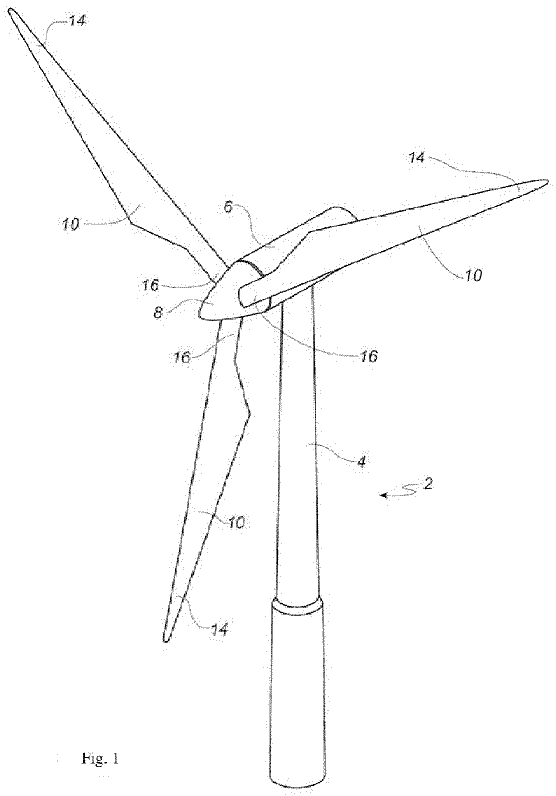

The following paragraphs describe the present disclosure with reference to FIGS. 1 to 7.

FIG. 1 illustrates a modern upwind wind turbine according to the so-called “Danish concept” with a tower (4), a nacelle (6) and a rotor with a substantially horizontal rotor shaft. The rotor includes a hub (8) and three blades (10) extending radially from the hub (8), each having a blade root (16) nearest the hub and a blade tip (14) farthest from the hub (8).

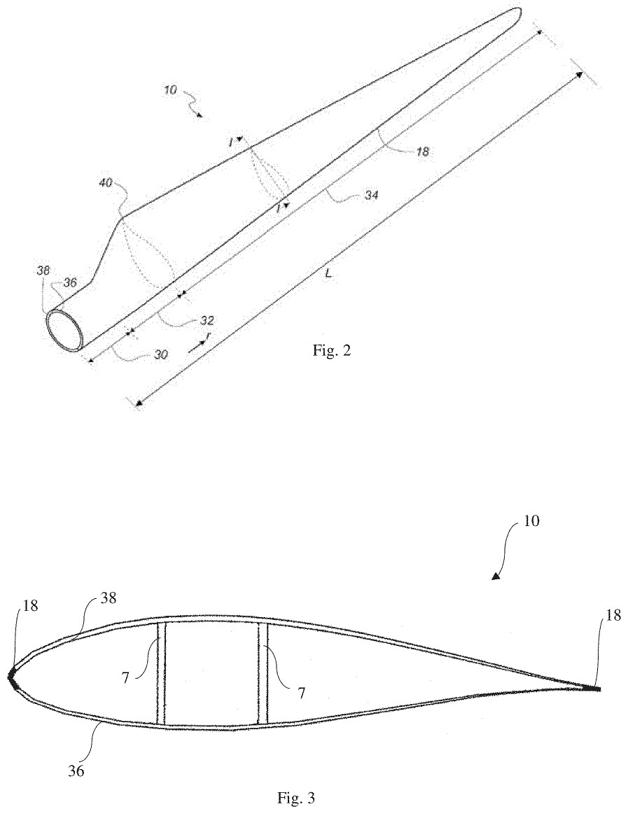

FIG. 2 shows a perspective view of a wind turbine blade (10). The wind turbine blade (10) has the shape of a conventional wind turbine blade and comprises a root region (30) closest to the hub, a profiled or an airfoil region (34) farthest away from the hub and a transition region (32) between the root region (30) and the airfoil region (34). The blade (10) comprises a leading edge (18) facing the direction of rotation of the blade (10), when the blade is mounted on the hub, and a trailing edge (20) facing the opposite direction of the leading edge (18).

The airfoil region (34) (also called the profiled region) has an ideal or almost ideal blade shape with respect to generating lift, whereas the root region (30) due to structural considerations has a substantially circular or elliptical cross-section, which for instance makes it easier and safer to mount the blade (10) to the hub (8). The diameter (or the chord) of the root region (30) may be constant along the entire root area (30). The transition region (32) has a transitional profile gradually changing from the circular or elliptical shape of the root region (30) to the airfoil profile of the airfoil region (34). The chord length of the transition region (32) typically increases with increasing distance r from the hub (8). The airfoil region (34) has an airfoil profile with a chord extending between the leading edge (18) and the trailing edge (20) of the blade (10). The width of the chord decreases with increasing distance r from the hub.

A shoulder (40) of the blade (10) is defined as the position, where the blade (10) has its largest chord length. The shoulder (40) is typically provided at the boundary between the transition region (32) and the airfoil region (34). FIG. 2 also illustrates the longitudinal extent L, length, or longitudinal axis of the blade.

It should be noted that, the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part (36) (may also be called as first shell half structure) and a suction side shell part (38) (may also be called as second shell half structure) that are glued to each other along bond lines at the leading edge (18) and the trailing edge of the blade (20).

FIG. 3 shows a schematic view of a cross section of the blade (10) along the axis I-I shown in FIG. 2. As previously mentioned, the blade (10) comprises a pressure side shell part (36) and a suction side shell part (38). The pressure side shell part (36) constitutes a load bearing structure (7). The pressure side shell part (36) and the suction side shell part (38) are connected via a plurality of shear webs (7). The shear webs (7) are substantially I-shaped structures. The shear web body comprises a sandwich core material, such as balsawood or foamed polymer, covered by a number of skin layers made of a number of fibre layers. The blade shells (36 and 38) may comprise further fibre-reinforcement at the leading edge and the trailing edge. Typically, the shell parts (36 and 38) are bonded to each other via glue flanges. The shear webs (7) act as load bearing structures and take on the load of the pressure and the suction side shell parts (36 and 38) in the wind turbine blade (10).

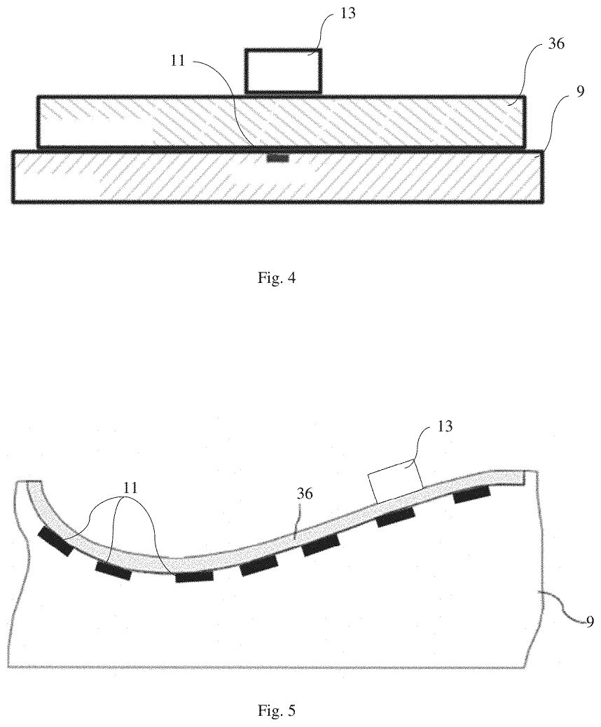

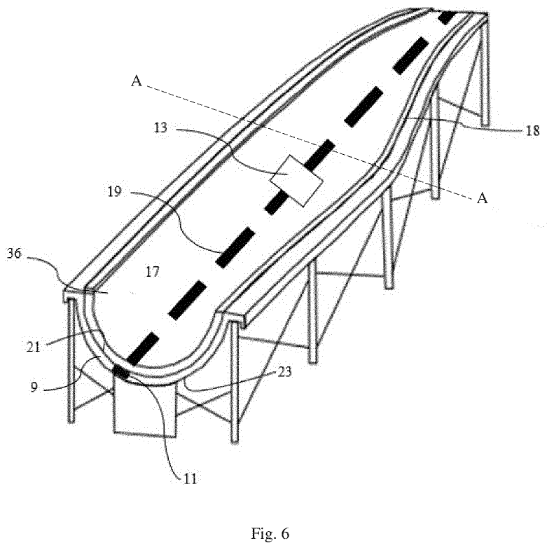

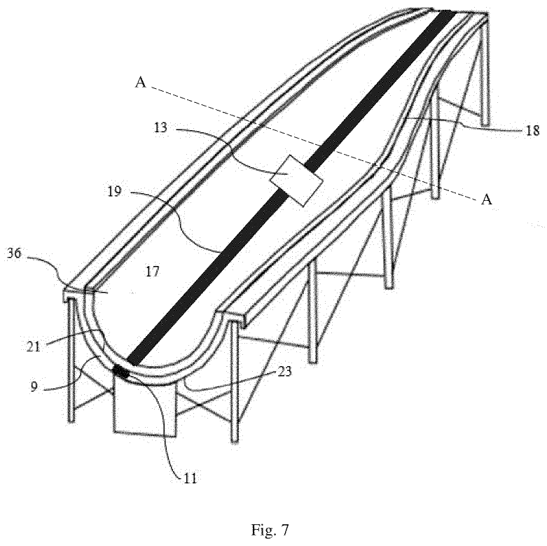

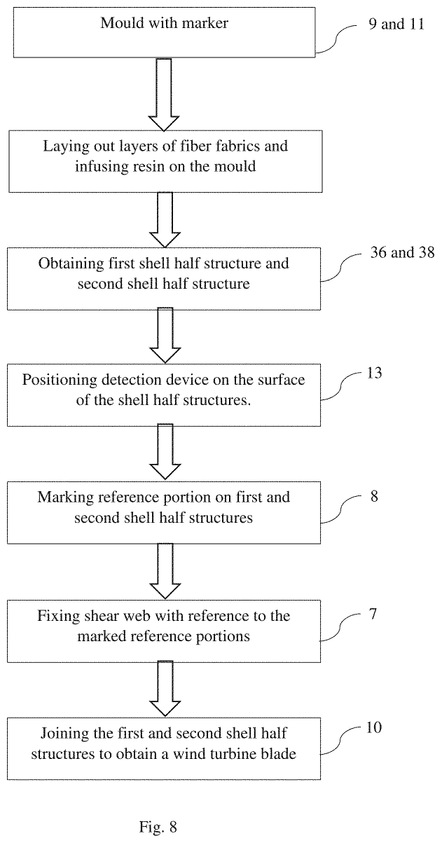

FIG. 4 illustrates a schematic front view of a mould (9) having a marker (11) for manufacturing shell half structure (36 and 38) of the wind turbine blade (10). Further, FIGS. and 6 illustrate a side view of the mould (9) along with marker (11) mounted on at pre-determined locations and a perspective view of the mould (9) mounted on a support structure (41). FIG. 8 is a flowchart of the method of manufacturing a wind turbine blade (10). The pressure and suction side shells (36 and 38) of the wind turbine blade (10) are manufactured using the mould (9) as shown in FIGS. 5 and 6. The mould (9) may be defined with an outer surface (23) and an inner surface (21). The inner surface (21) of the mould (9) is aerodynamic and the mould (9) may be defined with at least one cavity or groove for housing a marker (11). The marker (11) may be a metallic or non-metallic component. The material of the marker (11) may be chosen such that the density of the stirp (11) is significantly different from the density of the material used for the mould (9). Metallic materials such as aluminium may be preferably used since the coefficient of thermal expansion is similar to that of the mould (9) material. In an embodiment, the marker (11) may also be embedded within the mould (9) such that the marker (11) is not visible to user. The marker (11) may be provisioned at a distance ranging from 20 mm to 150 mm from the inner surface (21) of the mould (9). Further, the location at which the markers (11) are embedded in the mould (9) may already be determined using suitable methods. For instance, if a load bearing structure such as a shear web (7) or shear box is to be mounted on the pressure side shell part (36), an optimal position for mounting the shear web (7) is determined by calculating the points where the pressure side shell parts (36) may experience maximum stress during the rotation of the wind turbine blade (10). Further, the shear web (7) acts as a supporting structure for the pressure and suction side shell parts (36 and 38) and prevents the pressure and suction side shell parts (36 and 38) from collapsing due to self-weight and other forces experienced during the rotation of the wind turbine blade (10). The location where the shear webs (7) are to be mounted on the pressure and suction side shell parts (36 and 38) are determined such that the self-weight and the forces experienced by the pressure and suction side shell parts (36 and 38) of the wind turbine blade (10) during rotation is evenly distributed throughout the shear web (7). These locations may be determined by conducting suitable tests on the wind turbine blade (10) and the marker (11) may be embedded in the mould (9) in these pre-determined locations.

In addition to the shear webs (7), the marker (11) may also be provided at locations where other structures may be mounted with reference to location of the marker (11). The other structures which may be mounted such as but not be limited to a box beam, a spar beam, a box spar or any other load bearing structures known in the art may be used in the wind turbine blade (10).

Further, the mould (9) of the above disclosed configuration may be further used for manufacturing the pressure and suction side shell parts (36 and 38). Initially, a blade gel coat or primer is typically applied to the mould (9). Further, fiber reinforcement and/or fiber fabrics are placed into the mould (9). Multiple layers of fiber fabrics may be positioned on the mould (9) and the layers of fiber fabrics on the mould (9) may include aramid fiber fabrics, glass fiber fabrics, carbon fiber fabrics or hybrid fiber fabrics made of glass and carbon. Other, fiber fabrics not limiting to the above mentioned fabrics which are known in the art may also be used. Further, placing of the fiber fabrics on the mould (9) may be followed by resin infusion. A vacuum is typically used to draw epoxy resin material into the mould (9) and the resin is allowed to be cured. Several other moulding techniques are known for manufacturing wind turbine blades, including compression moulding and resin transfer moulding. Not limiting to the above-mentioned techniques, any of the methods of manufacturing pressure and suction shell which are known in the art may be used.

Further, once the pressure and suction side shell parts (36 and 38) are cured, a detection device (13) may be positioned or glided on inner surface (17) of the shell parts (36 or 38). In an embodiment, the detection device (13) may be a radar type detection device. As the detection device (13) is glided or moved over the inner surface (17) of the shell parts (36 or 38), the location of the marker (11) are suitably indicated on the detection device (13). Due to difference in densities between the marker (11) and the mould (9) material, the location of the marker (11) inside the mould (9) are clearly displayed on the detection device (13). The detection device (13) may be a standard radar detection device or radar type wall scanner. The detection device (13) emits high frequency radio waves and when these radio waves travel through the mould (9) and are reflected back when the radio waves come in contact with the marker (11) housed inside the mould (9). The reflected waves which are received by the detection device (13) are suitably indicated and this is an indication of the location of marker (11) in the mould (9). Once the location of the marker (11) is detected by the detection device (13), the operator may mark the inner surface (17) of the shell parts (36 or 38) with suitable reference portions (19). These reference portions (19) on the inner surface (17) of the shell parts (36 or 38) may be 500 mm in length. The width of the reference portions (19) may range from 15 mm to 20 mm and the thickness of the reference portions (19) may be lesser than 1 mm. The reference portions (19) may be strips of rectangular cross-section which may act as markers and may be placed at every 2000 mm in the mould (9). The strips may also be placed at a distance ranging from 500 mm to 3000 mm. The operator may further position the shear web (7) on the reference portions (19) and the shear web (7) may be suitably joined to the inner surface (17) of the shell parts (36 or 38) by a suitable adhesive. The operator may also position other critical components such as sensors on the shell half structure (36 and 38) using these reference portions (19) as reference points.

FIG. 7 illustrates an embodiment of the mould mounted on a support structure from the FIG. 6. In an embodiment, the reference portion (19) on the on the inner surface (17) of the shell parts (36 or 38) may be a continuous indicating means as seen from FIG. 7. Further, the markers (11) that are embedded in the mould (9) may also be a single unitary member that extends throughout the length of the mould (9).

In an embodiment, the operator may also use the reference portions (19) for positioning of fiber fabrics on the mould (9). For instance, excessive layers of fiber fabrics may be required to be placed on the sides of the mould (9) when compared to the central region of the mould (9). The operator may make use of the detection device (13) for placing the fiber fabrics on the mould (9).

Further, after the shear web (7) or shear box is positioned in the shells (36 or 38) based on the reference portions (19). After positioning of the shear web (7), the pressure and suction shell parts (36 and 38) are joined together. The shell parts (36 and 38) may be assembled by bonding them together along a peripheral edge (18) of the shell parts (36 and 38). The peripheral portion (18) along the trailing and leading edges of the shell parts (36 and 38) may be applied with a suitable bonding paste or adhesive and the shell parts (36 and 38) may be suitably joined together to form the wind turbine blade (10).

In an embodiment of the disclosure, the total time for manufacturing the wind turbine blade (10) is reduced since, markings on the inner surface (17) of the shell parts (36 or 38) are made easily by sliding and detecting the location of the marker (11) using a detection device. The above method consumes lesser time when compared to conventional methods of arch tools which require time in assembling and orienting the reference portions.

In an embodiment, the method of the present disclosure provides accurate locations of the reference portions (19) on the shell parts (36 and 38) for accurate positioning of the shear web (7).

In an embodiment, the method of the present disclosure provides the accurate location of marker (11), irrespective of the evenness of the floor where the wind turbine blade (10) is housed.

The invention is not limited to the embodiments described herein and may be modified or adapted without departing from the scope of the present invention.

### Referral Numerals

| Referral numeral | Description |
|---|---|
| 2 | Wind turbine |
| 4 | Tower |
| 6 | Nacelle |
| 7 | Shear web |
| 8 | Hub |
| 9 | Mould |
| 10 | Blade |
| 11 | Marker |
| 13 | Detection device |
| 14 | Blade tip |
| 16 | Blade root |
| 17 | Inner surface of the shell parts |
| 18 | Leading/peripheral edge |
| 19 | Reference portions |
| 20 | Trailing edge |
| 21 | Inner surface of the mould |
| 23 | Outer surface of the mould |
| 30 | Root region |
| 32 | Transition region |
| 34 | Airfoil region |
| 36 | Pressure side shell part |
| 38 | Suction side shell part |
| 40 | Shoulder |
| 41 | Supporting structure |

### Itemized List of Embodiments

item 1. A method of manufacturing a shell 36 and 38 of a wind turbine blade 10, the method comprises:

providing a mould 9 having a marker 11 at pre-determined locations;

laying one or more layers of fiber fabrics on surface of the mould 9 to form a shell half structure 36 and 38;

infusing resin through the one or more layers of fiber fabrics and subsequently curing the same to obtain the shell half structure 36 and 38;

marking a reference portion 19 on the shell half structure 36 and 38 to assemble one or more components in the shell half structure 36 and 38, by detecting a location of the marker 11 in the mould 9 by a detection device 13.

item 2. The method according to item 1, wherein the marker 11 is provided along a length of the mould 9 in a continuous or segmented manner.

item 3. The method according to item 1 or item 2, wherein the marker 11 is metallic or non-metallic strip.

item 4. The method according to any of the preceding items, wherein the location of the marker 11 is detected by positioning the detection device 13 on the surface of the shell half structure 36 and 38.

item 5. The method according to any of the preceding items, wherein the detection device 13 is a radar type detection device.

item 6. The method according to any of the preceding items, wherein the reference portion 19 on the surface of the shell half structure 2 are made at a distance ranging from 500 mm to 3000 mm along the surface of the shell half structure 2.

item 7. The method according to any of the preceding items, wherein the reference portion 19 on the surface of the shell half structure 2 is continuous.

item 8. The method according to any of the preceding items, wherein the marker 11 is made of at least one of steel or aluminum.

item 9. The method according to any of the preceding items, wherein the one or more components positioned on the shell half structure 2 with reference to the detected position of the marker 11 includes a shear web 7, box beam, spar beam and box spar.

item 10. A method of manufacturing a wind turbine blade 10 having a profiled contour including a pressure side 36 and a suction side 38, and a leading edge 18 and a trailing edge 20 with a chord having a chord length extending therebetween, the wind turbine blade 10 extending in a spanwise direction between a root end and a tip end, the method comprises: providing a mould 9 having a marker 11 at pre-determined locations;

laying one or more layers of fiber fabrics, on surface of the mould 9 to form a first shell half structure 36 and a second shell half structure 38 separately;

infusing resin through the one or more layers of fiber fabrics with a resin and subsequently curing the same to obtain the first and the second shell half structure 36 and 38;

marking a reference portion 8 on at least one of the first shell half and the second shell half structure 36 and 38, by detecting a location of the marker 11 in the mould 9 using a detection device 13;

fixing a shear web 7 with reference to the marked reference position 19 in an inner surface 17 of at least one of the first shell half structure 36 and the second shell half structure 38;

joining the first shell half structure 36 with the second shell half structure 38 to obtain a wind turbine blade 10;

item 11. The method according to item 10, wherein the marker 11 is provided along a length of the mould 9 in a continuous or segmented manner.

item 12. The method according to item 10 or item 11, wherein the marker 11 is metallic or non-metallic strip.

item 13. The method according to any of items 10-12, wherein the location of the marker 11 is detected by positioning the detection device 13 on the surface of the shell half structure 36 and 38.

item 14. The method according to any of items 10-13, wherein the detection device 13 is a radar type detection device.

item 15. The method according to any of items 10-14, wherein the reference portions 19 on the surface of the shell half structure 2 are made at a distance ranging from 500 mm to 3000 mm along the surface of the shell half structure 5.

item 16. The method according to any of items 10-15, wherein the reference portion 19 on the surface of the shell half structure 2 is continuous.

item 17. The method according to any of items 10-16, wherein marker 11 is made of at least one of steel or aluminum.

item 18. The method according to any of items 10-17, wherein the layers of fiber fabrics on the mould 9 include aramid fiber fabrics, glass fiber fabrics, carbon fiber fabrics or hybrid fiber fabrics made of glass and carbon.

item 19. A mould 9 for manufacturing a shell 36 of a wind turbine blade 10, the mould 9 comprising:

an inner surface 21 and an outer surface 23, wherein the inner surface 21 is defined by an aerodynamic shape of the wind turbine blade 10 and extends in a spanwise direction;

at least one marker 11 embedded within the inner surface 21 of the blade shell 36 and 38 at a predetermined depth from the inner surface 21 of the blade shell 36 and 38, wherein, the location of the marker 11 is detectable by a detection device 13 for positioning a component on an inner surface 17 of the blade shell 36 and 38.

item 20. The mould 9 according to item 19, wherein the at least one marker 11 is integrally laid in the mould 9 or positioned in a groove defined in the inner surface 17 of the mould 9.

item 21. The mould 9 according to item 19 or item 20, wherein the predetermined depth from the inner surface 17 ranges from about 20 mm to about 150 mm.

item 22. A system for determining a reference position in a wind turbine blade 10 to mount one or more components on the shell half structure 36 and 38, the system comprising:

a mould 9 according to any of items 17-21; and

a detection device 13 configured to detect the location of at least one marker 11 in the mould 9 by positioning a detection device 13 on the surface of a shell half structure 36 and 38.

1. A method of manufacturing a shell (36 and 38) of a wind turbine blade (10), the
method comprises:
providing a mould (9) having a marker (11) at pre-determined locations;
laying one or more layers of fiber fabrics on surface of the mould (9) to form a shell half structure (36 and 38);
infusing resin through the one or more layers of fiber fabrics and subsequently curing the same to obtain the shell half structure (36 and 38);
marking a reference portion (19) on the shell half structure (36 and 38) to assemble one or more components in the shell half structure (36 and 38), by detecting a location of the marker (11) in the mould (9) by a detection device (13)
wherein the detection device (13) is a radar type detection device.

2. The method according to claim 1, wherein the marker (11) is provided along a length of the mould (9) in a continuous or segmented manner.

3. The method according to claim 1, wherein the marker (11) is metallic or
non-metallic strip.

4. The method according to claim 1, wherein the location of the marker (11) is detected by positioning the detection device (13) on the surface of the shell half structure (36 and 38).

5. The method according to claim 1, wherein the reference portion (19) on the surface of the shell half structure (2) are made at a distance ranging from 500 mm to 3000 mm along the surface of the shell half structure (2).

6. The method according to claim 1, wherein the reference portion (19) on the surface of the shell half structure (2) is continuous.

7. The method according to claim 1, wherein the marker (11)
is made of at least one of steel or aluminum.

8. The method according to claim 1, wherein the one or more components positioned on the shell half structure (2) with reference to the detected position of the marker (11) includes a shear web (7), box beam, spar
beam and box spar.

9. A method of manufacturing a wind turbine blade (10) having a profiled contour including a pressure side (36) and a suction side (38), and a leading edge (18) and a trailing edge (20) with a chord having a chord length extending
therebetween, the wind turbine blade (10) extending in a spanwise direction between a root end and a tip end, the method comprises:
providing a mould (9) having a marker (11) at pre-determined locations;
laying one or more layers of fiber fabrics, on surface of the mould (9) to form a first shell half structure (36) and a second shell half structure (38) separately; infusing resin through the one or more layers of fiber fabrics with a resin and subsequently curing the same to obtain the first and the second shell half structure (36 and 38);
marking a reference portion (8) on at least one of the first shell half and the second shell half structure (36 and 38), by detecting a location of the marker (11) in the mould (9) using a detection device (13);
fixing a shear web (7) with reference to the marked reference position (19) in an inner surface (17) of at least one of the first shell half structure (36) and the second shell half structure (38);
joining the first shell half structure (36) with the second shell half structure (38) to obtain a wind turbine blade (10);

10. The method according to claim 9, wherein the marker (11) is provided along a length of the mould (9) in a continuous or segmented manner.

11. The method according to claim 9, wherein the marker (11) is metallic or
non-metallic strip.

12. The method according to claim 9, wherein the location of the marker
(11) is detected by positioning the detection device (3) on the surface of the shell half structure (36 and 38).

13. The method according to claim 9, wherein the detection device (13) is a radar type detection device.

14. The method according to claim 9, wherein the reference portions (19)
on the surface of the shell half structure (2) are made at a distance ranging from 500 mm to 3000 mm along the surface of the shell half structure (5).

15. The method according to claim 9, wherein the reference portion (19) on the surface of the shell half structure (2) is continuous.

16. The method according to claim 9, wherein the marker (11) is made of at least one of steel or aluminum.

17. The method according to claim 9, wherein the layers of fiber fabrics
on the mould (9) include aramid fiber fabrics, glass fiber fabrics, carbon fiber fabrics or hybrid fiber fabrics made of glass and carbon.

18. A mould (9) for manufacturing a shell (36) of a wind turbine blade (10), the mould (9) comprising:
an inner surface (21) and an outer surface (23), wherein the inner surface (21) is defined by an aerodynamic shape of the wind turbine blade (10) and extends in a spanwise direction;
at least one marker (11) embedded within the inner surface (21) of the blade shell (36 and 38) at a predetermined depth from the inner surface (21) of the blade shell (36 and 38), wherein, the location of the marker (11) is detectable by a detection device (13) for positioning a component on an inner surface (17) of the blade shell (36 and 38),
wherein the detection device (13) is a radar type detection device.

19. The mould (9) according to claim 18, wherein the at least one marker (11) is integrally laid in the mould (9) or positioned in a groove defined in the inner
surface (17) of the mould (9).

20. The mould (9) according to claim 18, wherein the predetermined depth from the inner surface (17) ranges from about 20 mm to about 150 mm.

21. A system for determining a reference position in a wind turbine blade (10) to mount one or more components on the shell half structure (36 and 38), the system comprising:
a mould (9) according to claim 18; and
a detection device (13) configured to detect the location of at least one marker (11) in the mould (9) by positioning a detection device (13) on the surface of a shell half structure (36 and 38),
wherein the detection device (13) is a radar type detection device.
